(19) United States
(12) Patent Application Publication
(10) Pub. No.: US 2014/0009409 A1
(43) Pub. Date: Jan. 9, 2014

(54) MULTI-FUNCTIONAL STYLUS FOR TOUCH DEVICES

(71) Applicant: Ming-Yen Wang, New Taipei City (TW)

(72) Inventor: Ming-Yen Wang, New Taipei City (TW)

(21) Appl. No.: 13/680,567

(22) Filed: Nov. 19, 2012

(30) Foreign Application Priority Data
Jul. 6, 2012 (TW) 101213101

(51) Int. Cl. G06F 3/033; G06F 3/041

(52) U.S. Cl. CPC G06F 3/033; G06F 3/041
USPC 345/173

(57) ABSTRACT

A multi-functional stylus for touch device has a body and a plug pivotally mounted inside the body. The body has a tip formed on one end of the body and a receiving slot formed in a periphery of the body. The receiving slot matches the plug. The plug pertains to a PJ-series earphone jack plug and one end of the plug is pivotally mounted in one end of the receiving slot. While the stylus is not operated, the plug can be plugged in an earphone jack of a mobile touch device. Furthermore, the body is pivoted with respect to one end of the plug plugged in the touch device at an adjustable angle between the body and a touch device so that the touch device can be stood up on a plane at an appropriate view angle. Accordingly, the stylus can provide multiple functions based on users' demands

### BACKGROUND OF THE INVENTION

1. Field of the Invention

The present invention relates to a stylus and more particularly to a multi-functional stylus for touch devices.

2. Description of the Related Art

Touch screen interface may be the most popular operation interface of the latest technology industry. All sorts of electronic products, such as smart phones, notebook computers, tablet personal computers, digital cameras and the like, are equipped with the touch screen interface. Hence, the touch screen interface has gradually replaced the mechanical operation mode used by those early-stage electronic products.

However, when users use their fingers to touch the touch screen interface of the above-mentioned electronic products, the interface is prone to inadvertent touch that triggers unintended control option due to inaccurate positioning on a small touch screen (for example, on a smart phone), or unsmooth finger movement on the touch screen because of filthy fingers. To tackle those issues, manufacturers in the market provide a stylus for the purpose of accurate positioning

With reference to FIG. 6, the stylus has a body 90 and a tip 91 mounted on one end of the body 90. A through hole 92 is formed through the other end of the body 90 for a string to penetrate therethrough. A PJ-series earphone jack plug 94 is tied to the string 93 and serves to be plugged into an earphone jack of an electronic product so that the stylus can be conveniently carried around with the electronic product without worry of getting lost. When the stylus is operated, users can hold the body 90 and touch the tip 91 on a touch screen to control an electronic product with the touch screen. Hence, the stylus facilitates users' accurate control of electronic products, allows users to simulate it as a pen to write when there is a need for writing on a touch screen, and can be operated by users in their accustomed manner.

Although the foregoing stylus is available for users to accurately control electronic products, the conventional stylus is plugged in an electronic product through the earphone jack plug 94 and it is easy for the electronic product or the stylus to be damaged by the collision therebetween and/or with something else around for the sake of random movement of the stylus when the electronic product is stored.

### SUMMARY OF THE INVENTION

An objective of the present invention is to provide a multi-functional stylus for touch device capable of being fixed on a touch device and serving as a stand for supporting the touch device to stand up on a plane.

To achieve the foregoing objective, the multi-functional stylus for touch device has a body and a plug.

The body has a tip and a receiving slot.

The tip is mounted on one end of the body.

The receiving slot is formed in a periphery of the body, and is parallel with a longitudinal direction of the body.

The plug matches the receiving slot in shape and has a PJ-series earphone jack plug mounted on one end of the plug. The other end of the plug is pivotally mounted in the receiving slot.

The multi-functional stylus constructed according to the foregoing structure is available for users to accurately write on a mobile touch device with the tip of the body. When the stylus is not operated, the PJ-series earphone jack plug on one end of the plug is plugged in an earphone jack of the touch device so that the stylus can be fixed on the touch device, not only facilitating the storage and positioning of the stylus but also preventing the damage of the stylus and the touch device arising from random movement of the stylus tied to the touch device with a string. Additionally, the body is pivoted with respect to one end of the plug plugged in the touch device and an angle between the body and the touch device can be adjusted so that the touch device can be stood up on a plane with one side of the touch device and the tip of the body on the plane. The angle can be adjusted based on a user's demand to ensure an appropriate view angle to the touch device. Accordingly, the stylus of the present invention has multiple functions for users' selection.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a multi-functional stylus for touch devices in accordance with the present invention;

FIG. 2 is an exploded perspective view of the multi-functional stylus in FIG. 1;

FIG. 3 is a first operational side view of the multi-functional stylus in FIG. 1 plugged in an electronic product;

FIG. 4 is an operational perspective view of the multi-functional stylus in FIG. 1 plugged in an electronic product;

FIG. 5 is an operational rear view of the multi-functional stylus in FIG. 1 plugged in an electronic product; and

FIG. 6 is a perspective view of a conventional stylus for touch devices.

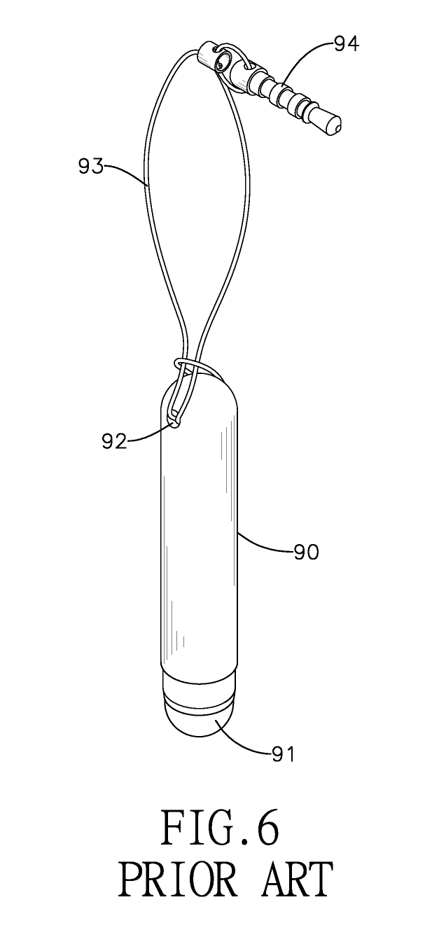

### DETAILED DESCRIPTION OF THE INVENTION

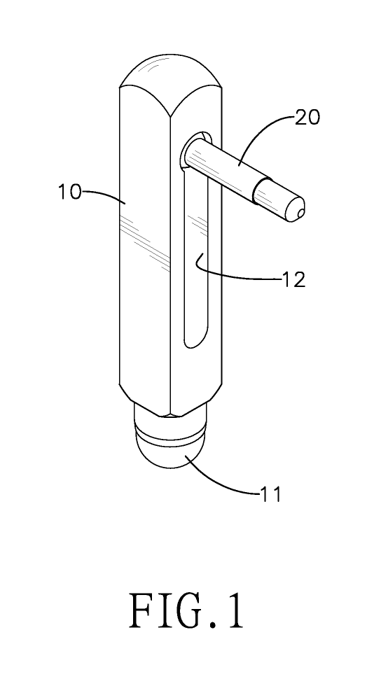

With reference to FIG. 1, a multi-functional stylus for touch device in accordance with the present invention has a body 10 and a plug 20 pivotally mounted in the body 10.

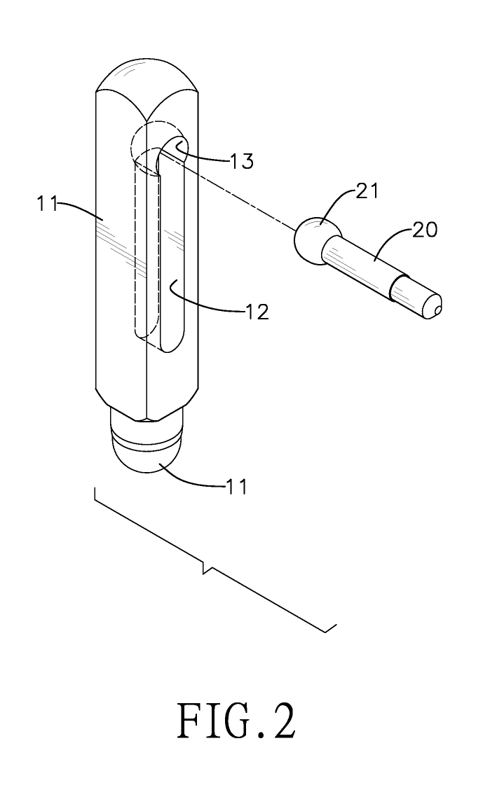

With reference to FIG. 2, the body 10 is in the form of a rectangular prism and has a tip 11 and a receiving slot 12. The tip is mounted on one end of the body 10. The receiving slot 12 is formed in a periphery of the body 10, is parallel with a longitudinal direction of the body 10, and has a sphere-shaped pivoting recess 13. The pivoting recess 13 is formed in one end of the receiving slot 12.

The plug 20 matches the receiving slot 12 in shape and has a pivoting part 21 and a PJ-series earphone jack plug. The pivoting part 21 is formed on one end of the plug 20, matches the pivoting recess 13 in shape, and is sphere-shaped. The PJ-series earphone jack plug is mounted on the other end of the plug 20. When the pivoting part 21 is pivotally mounted in the pivoting recess 13 of the receiving slot 12, the plug 20 corresponds to the receiving slot 12, and is pivotable with respect to the body 10 to be pivoted into or out of the receiving slot 12.

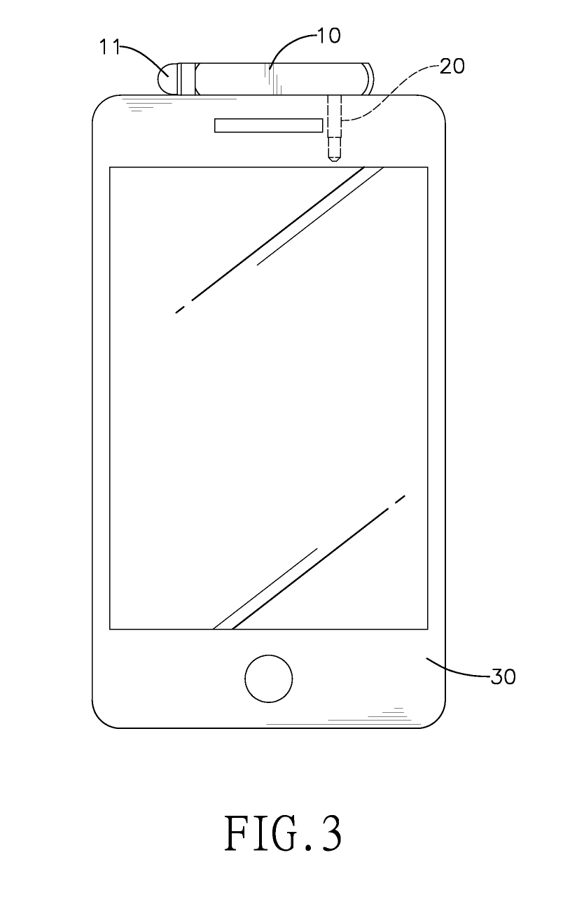

When the stylus constructed according to the foregoing structure is operated, the plug 20 is pivoted into the receiving slot 12 for users to hold the body 10 and touch a mobile touch device 30 with the tip 11. Hence, users are allowed to accurately write on the touch device 30. With reference to FIG. 3, the plug 20 is pivoted out of the receiving slot 12 and is at a right angle with respect to the body 10 so that the plug 20 can be plugged in an earphone jack of the touch device 30 and the body 10 can be fixed on the touch device 30. Besides being conveniently stored and fastened, the random movement of a conventional stylus that is tied to a touch device with a string and the resultant damage to the stylus and a touch device to which the stylus is attached can be avoided.

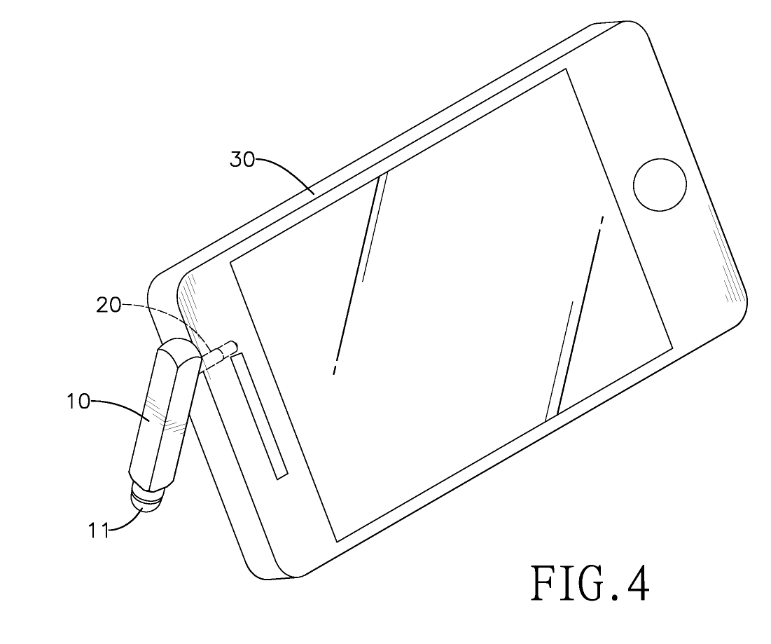

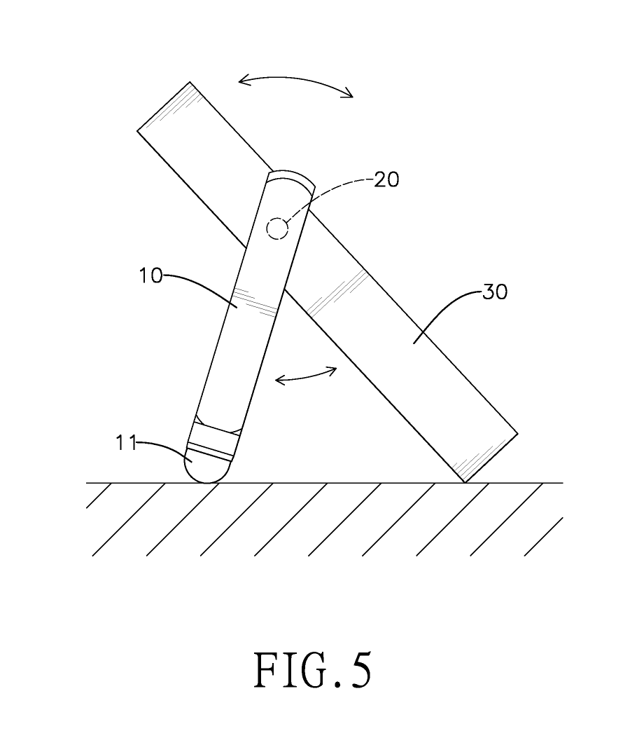

With reference to FIGS. 4 and 5, the body 10 is pivoted with respect to one end of the plug 20 plugged in a touch device 30 and an angle between the body 10 and a touch device 30 can be adjusted so that the touch device 30 can be stood up on a plane with one side of the touch device 30 and the tip 11 of the body 10 on the plane. The angle can be adjusted based on a user's demand to ensure an appropriate view angle to the touch device 30 for the purpose of comfort operation. Accordingly, the stylus of the present invention is multi-functional and can be selectively operated depending on a user's demand.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A multi-functional stylus for touch device comprising:
a body having:
a tip mounted on one end of the body; and
a receiving slot formed in a periphery of the body, and being parallel with a longitudinal direction of the body; and
a plug matching the receiving slot in shape and having two ends and a PJ-series earphone jack plug mounted on one of the ends of the plug, wherein the other end of the plug is pivotally mounted in the receiving slot.

2. The multi-functional stylus as claimed in claim 1, wherein a pivoting recess is formed in one end of the receiving slot, and a pivoting part is formed on one end of the plug opposite to the PJ-series earphone jack plug and is pivotally mounted in the pivoting recess.

3. The multi-functional stylus as claimed in claim 2, wherein
the pivoting recess is sphere-shaped; and
the pivoting part corresponding to the pivoting recess is sphere-shaped.

4. The multi-functional stylus as claimed in claim 1, wherein the body is in the form of a rectangular prism.

5. The multi-functional stylus as claimed in claim 2, wherein the body is in the form of a rectangular prism.

6. The multi-functional stylus as claimed in claim 3, wherein the body is in the form of a rectangular prism.
